(19) United States
(12) Patent Application Publication
(10) Pub. No.: US 2004/0117838 A1
(43) Pub. Date: Jun. 17, 2004

(54) Headend pre-processing media guide support for personal media exchange network

(76) Inventors: Jeyhan Karaoguz, Irvine, CA (US); James Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,458

(22) Filed: Sep. 30, 2003

Related U.S. Application Data
(60) Provisional application No. 60/432,472, filed on Dec. 11, 2002.
(60) Provisional application No. 60/443,894, filed on Jan. 30, 2003.
(60) Provisional application No. 60/453,787, filed on Mar. 11, 2003.
(60) Provisional application No. 60/457,179, filed on Mar. 25, 2003.
(60) Provisional application No. 60/443,897, filed on Jan. 30, 2003.

(51) Int. Cl. H04N 7/173; G06F 13/00; H04N 5/445; G06F 3/00; H04N 7/16

(52) U.S. Cl. 725/86; 725/135; 725/39; 725/134

(57) ABSTRACT

Certain embodiments of the invention may be found in a method and system for processing media for selection and playback in a communication network and may comprise determining when personal media and/or broadcast media is scheduled in at least one constructed display and acquiring information related to the personal media and/or broadcast media from at least one media provider. The constructed display may be a channel guide, a device guide and/or a media guide that is formatted in a graphical user interface. Subscription information related to the media broadcast scheduled in the constructed display may be accessed in order to determine whether the constructed display should be updated. The updated constructed display may be transferred to a home, where it may be displayed on a television screen.

### CROSS-REFERENCE TO RELATED APPLICATIONS/INCORPORATION BY REFERENCE

This application makes reference to, claims priority to, and claims the benefit of:

U.S. Provisional Application Serial No. 60/432,472 (Attorney Docket No. 14185US01 01001 P-BP-2800) filed Dec. 11, 2002;

U.S. Provisional Application Serial No. 60/443,894 (Attorney Docket No. 14274US01 01002P-BP-2801) filed Jan. 30, 2003;

U.S. Provisional Application Serial No. 60/453,787 (Attorney Docket No. 14762US01 01032P-BP-2824) filed Mar. 11, 2003;

U.S. Provisional Application Serial No. 60/457,179 (Attorney Docket No. 14825US01 01015P-BP-2831) filed Mar. 25, 2003; and

U.S. Provisional Application Serial No. 60/443,897 (Attorney Docket No. 14276US01 01004P-BP-2803) filed Jan. 30, 2003.

This application also makes reference to:

U.S. application Ser. No. (Attorney Docket No. 14185US02 01001P-BP-2800) filed Sep. 8, 2003; and

U.S. application Ser. No. (Attorney Docket No. 14274US02 01002P-BP-2801) filed Sep. 11, 2003.

All of the above stated applications are incorporated herein by reference in their entirety.

### FIELD OF THE INVENTION

Certain embodiments of the present invention relate to the scheduling of media content for consumption. In particular, certain embodiments of the present invention relate to the scheduling of personal media content and subscription media content into a media guide in a personal media exchange network.

### BACKGROUND OF THE INVENTION

Information stored on a personal computer (PC) is accessed differently in a personal computer environment than in a television (TV) environment, and the information accessed is typically very different in the both environments. Information that is typically accessed in a personal computer environment may include digital pictures, formatted text, video clips and/or email messages and may be formatted in one of various file types or formats. The files are typically stored and managed using a personal computer file system comprising a file system having a directory and/or file folder structure. Information that is accessed in a television environment typically includes broadcast program content. A television channel guide is typically provided to inform a user of the scheduled program options. This guide is sometimes broadcasted on a dedicated channel and a schedule continuously scrolls across the television screen.

In a personal computer environment, information may be accessed via an Internet web browser, file transfer protocol (FTP) commands, or email attachments. For example, a personal computer employing a web browser is often used to access media, data, and services distributed over various web sites on the Internet. Files of digital media referred to digital media files may be downloaded from the web sites and stored in the personal computer. A user may store a list of web site addresses in a “favorites” folder or favorites menu in order to easily gain access at a later date to the web sites corresponding to the stored addresses.

Also, a personal computer is often utilized to access media stored on a media peripheral via a wired link. For example, in the case of a digital camera, a user may have to execute the following steps: attach a cable between the personal computer and the digital camera; power up the digital camera; place the camera in a download mode; and/or execute a personal computer application that may be adapted to copy or transfer the image files between the digital camera to the personal computer via the attached cable.

A personal computer is often utilized to acquire media and data via email attachments. For example, a user of a personal computer may receive an email from a family member containing file attachments with digital pictures. After opening the email and accessing the attachments, the user may move the file attachments containing the digital pictures to a file folder such as “My Pictures” on the hard disk of the user's personal computer.

In a television environment, broadcast programs are made available at scheduled times. A cable television (CATV) or satellite television (SATV) provider typically provides a television channel guide showing scheduled broadcast programs. A user may view the television channel guide to identify a particular time when a broadcast program is being broadcasted and the channels on which the program is being aired. The user may then tune to a specific channel identified in the television channel guide in order to view a particular broadcast program. The CATV or SATV provider may also allow a user to purchase special event broadcasts in a manner in which a user or subscriber pays for a program prior to viewing the program.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Certain aspects of the invention may be found in a method and system for processing media for selection and playback in a communication network. The method may comprise the steps of determining when personal media and/or broadcast media is scheduled in at least one constructed display and acquiring information related to the personal media and/or broadcast media from at least one media provider. The constructed display may be a channel guide, a device guide and/or a media guide and may be formatted in a graphical user interface. Notwithstanding, the subscription information related to the media broadcast scheduled within the constructed display may be accessed in order to determine whether the constructed display should be updated. Accordingly, the updated constructed display may be transferred, for example, to a home, where it may be displayed.

In accordance with an aspect of the invention, broadcast media content corresponding to the accessed subscription information may be stored and the stored broadcast media content may be communicated or transferred to a location where the updated constructed display is presented. Representations of updated broadcast media and the personal media may be generated and both may be combined within the constructed display based on the acquired information relating to the personal media and/or broadcast media. In another aspect of the invention, presentation of the broadcast media and/or the personal media via the updated constructed display may be rescheduled in order to prevent scheduling conflicts.

Another embodiment of the invention may provide a machine-readable storage, having stored thereon, a computer program having at least one code section for processing media for selection and playback in a communication network. The at least one code section may be executable by a machine, thereby causing the machine to perform the steps as described above for processing media for selection and playback in a communication network.

Aspects of the system for processing media for selection and playback in a communication network may comprise at least one processor that may be adapted to determine when personal media and/or broadcast media is scheduled in a constructed display and acquiring information related to the personal media and/or broadcast media from at least one media provider. The constructed display may be a channel guide, a device guide and/or a media guide and may be formatted in a graphical user interface. The processor may be a headend processor or a media guide pre-processor. Subscription information related to the media broadcast scheduled in the constructed display may be accessed in order to determine whether the constructed display should be updated. The updated constructed display may subsequently be transferred by the processor to, for example, a home where it may be displayed on a television screen or other display.

In an aspect of the invention, broadcast media content corresponding to the accessed subscription information may be stored by the processor and the stored broadcast media content may be communicated to a location where the updated constructed display is presented. Representations of updated broadcast media and the personal media may be generated and combined by the processor within the constructed display based on the acquired information that is related to the personal media and/or broadcast media. In another aspect of the invention, presentation of the broadcast media and/or the personal media via the updated constructed display may be rescheduled by the processor in order to prevent scheduling conflicts.

Another embodiment of the invention may also be found in a method for processing media for selection and playback in a communication network that comprises the step of determining from outside a home, when personal media and/or broadcast media is scheduled in at least one constructed display that is displayed within the home. Information related to the personal media and/or broadcast media may be acquired from at least one media provider and the constructed display updated from outside the home based on the acquired information. The updated information may be transferred and presented in the constructed display within the home. Subscription information related to the media broadcast that is scheduled in the constructed display that is displayed within the home may be accessed from outside the home.

Broadcast media content corresponding to the accessed subscription information may be stored outside the home and the stored information may be communicated to the home where a representation of the broadcast media is presented in the constructed display. The constructed display may be a channel guide, device guide and/or media guide, which may be formatted as a graphical user interface.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an embodiment of a personal media exchange network 100 that may be utilized in connection with supporting scheduling of personal media content and subscription media content, in accordance with various aspects of the present invention.

FIG. 2 is a flowchart illustrating an embodiment of an exemplary method 200 that may be utilized for scheduling personal media content and subscription media content into a media guide on the personal media exchange network 100 of FIG. 1, in accordance with various aspects of the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the invention may be found in a method and system for processing media for selection and playback in a communication network. Certain aspects of the method may comprise the step of determining when personal media and/or broadcast media is scheduled in at least one constructed display and acquiring information related to the personal media and/or broadcast media from at least one media provider. The constructed display may be a channel guide, a device guide and/or a media guide and may be formatted in a graphical user interface format. Subscription information related to the media broadcast scheduled in the constructed display may be accessed in order to determine whether the constructed display should be updated. The updated constructed display may be transferred to a home, where it may be displayed on a television screen, for example.

Broadcast media content corresponding to the accessed subscription information may be stored and the stored broadcast media content may be communicated to a location where the updated constructed display is presented. Representations of updated broadcast media and the personal media may be generated and combined in the constructed display based on the acquired information relating to the personal media and/or broadcast media. In another aspect of the invention, presentation of the broadcast media and/or the personal media via the updated constructed display may be rescheduled in order to prevent scheduling conflicts.

Another embodiment of the invention may also be found in a method for processing media for selection and playback in a communication network that comprises the step of determining from outside a home, when personal media and/or broadcast media is scheduled in at least one constructed display that is displayed within the home. Information related to the personal media and/or broadcast media may be acquired from at least one media provider and the constructed display may be updated from outside the home based on the acquired information. The updated information may be transferred and presented in the constructed display within the home. Subscription information related to the media broadcast that is scheduled in the constructed display that is displayed within the home may be accessed from outside the home.

Broadcast media content corresponding to the accessed subscription information may be stored outside the home and the stored information may be communicated to the home where a representation of the broadcast media is presented in the constructed display. The constructed display may be a channel guide, device guide and/or media guide, which may be formatted as a graphical user interface.

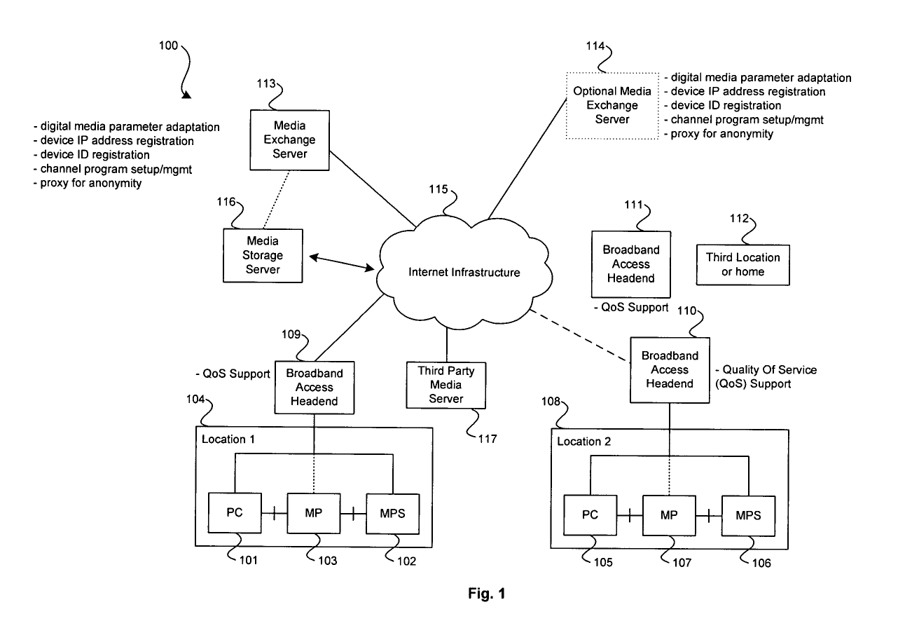

FIG. 1 is a diagram illustrating an embodiment of a personal media exchange network 100 that may be utilized in connection with supporting scheduling of personal media content and subscription media content, in accordance with various aspects of the present invention. Referring to FIG. 1, the personal media exchange network 100 may be a communication network comprising a media processing system (MPS) 101 located in a user's home 102, a headend infrastructure 105, an Internet infrastructure 107, a broadcast channel provider 117 and a third (3^{rd}) party media provider 113. The media processing system 101 interfaces to the headend infrastructure 105 and the headend infrastructure 105 interfaces to the Internet infrastructure 107. The broadcast channel provider 117 and a third (3^{rd}) party media provider 113 may both be coupled to the internet infrastructure 107. The media exchange network may be a communication network that may be adapted to facilitate the exchange or transfer of media.

In an embodiment of the invention, the personal media exchange network 100 may comprise a media peripheral 108 and a personal computer 109 located at the user's home 102. The media peripheral 108 may comprise a storage area or block 115. The personal computer 109 may also comprise a storage area or block 116. In accordance with an aspect of the invention, the media peripheral 108 and the personal computer 109 may be adapted to interface, via a wired and/or wireless connection, to the media processing system 101. The wireless connection may be, for example, Bluetooth or any 802.11x based protocols.

The personal computer 109 may comprise a desktop personal computer, a notebook personal computer, a personal digital assistant (PDA), a handheld computer, or any other computing device or media peripheral. The media peripheral 108 may include, for example, a digital camera, a digital camcorder, a MP3 player, a home jukebox system, a personal digital assistant, and a multimedia gateway device. The media processing system 101 may include a television screen for scheduling media content and/or for viewing the scheduled media content. In this regard, a media guide, device guide and/or a channel guide may be displayed on a television screen or other display and may be utilized to facilitate scheduling and/or selection of the media content.

The personal media exchange network 100 may also comprise other systems that may interface with the Internet infrastructure 107 including, for example, the third (3^{rd}) party media provider 113 which may be adapted to provide third (3^{rd}) party media content. The broadcast channel provider 117 may be adapted to provide broadcast channel program content, which may be distributed via the Internet infrastructure 107 and the headend infrastructure 106. For example, the broadcast program content may include videos, news, local or other television broadcasts including specialized channels in which a user may have to pay per use for program content.

The elements of the media exchange network may include various storage locations for storing digital media and/or data. For example, the third (3^{rd}) party media provider 113 includes a storage location 118 for storing media content such as, for example, movies, advertisements and games, for example. The storage location 103 of the third (3^{rd}) party media provider may be adapted to store user subscription and account information. The broadcast channel provider 117 may be adapted to store user subscription and account information in storage location 119. Broadcast media content may also be stored in storage location or storage block 120 of the broadcast channel provider. The headend infrastructure 105 may include a storage location 112 that may be adapted to store media content received from the third (3^{rd}) party media provider 113 and the broadcast channel provider 117.

The media processing system 101 may comprise a storage location 114 that may be adapted to locally store media and data such as personal media content. The storage location 114 may include a main storage and/or removable storage. The main storage may comprise, for example, a hard disk drive, a DVD player, a CD player, a floppy disk drive, random access memory (RAM), or any combination thereof. The DVD player and/or CD player may have read/write capability. The removable storage may include, for example, a memory card, a PCMCIA card, a compact flash card, or any combination thereof. The personal computer 109 may include a storage location or storage block 116 for storing various types of media files such as images, audio, video and/or text. The media peripheral 108 may also include a storage location or storage clock 115 for storing digital media content files.

The headend infrastructure 105 may comprise a central control device that may be configured to provide certain centralized functions. Exemplary centralized functions may include, but are not limited to, re-modulation, retiming, message accountability, contention control, diagnostic control and gateway access. For example, the headend infrastructure 105 may be a cable headend that may be utilized by a CATV provider.

The media processing system 101 may comprise a media exchange software (MES) platform 104 for scheduling personal media content into a media guide 110. The headend infrastructure 105 may comprise a media guide pre-processor 106 for scheduling both personal media content and subscription based media content into an updated media guide 111. As used herein, personal media content may comprise media content generated by a user of the media processing system 101. Additionally, subscription media content may comprise media content generated by a third (3^{rd}) party and broadcast programs that may be generated and provided by a service provider such as a CATV provider or a SATV provider, for example.

In accordance with an embodiment of the present invention, the media guide 110 may comprise a table of channels versus scheduled media content which may include personal media content, broadcast media content, and/or other third (3^{rd}) party media content. A user of the media processing system 101 may construct personal media channels, representations of which may be displayed in a media guide or media view 110. Personal media content may be presented into the personal media channels and representations of the personal media content may be displayed in the media guide. Such capability is provided by the media exchange platform 104. The source of the personal media content may be, for example, the media peripheral 108 and/or the personal computer 109.

The media processing system 101 may also have the capability to provide a device view and/or a media view from which media content may be scheduled into the media guide 110 by the user of the media processing system 101. A device view may comprise, a table of devices such as a compact disc jukebox player, remote personal computer, personal video recorder (PVR), DVD/CD player and/or MP3 player coupled to the personal media exchange network 100 versus media content categories. At least some of these devices may have read/write capability and may be coupled via a wired and/or wireless connection the communication network 100. The media content categories may be provided by these devices and may be displayed to the user of the media processing system 101 within the device view. Exemplary media content categories may include album titles, image files, image file types, video files, and/or video file types.

In accordance with an aspect of the invention, a media view may comprise a table of available media content categories on the personal media exchange network 100 versus specific media content, for example, track #1, image #3, and song #5, and may be displayed to the user of the media processing system 101. A user of the media processing system 101 may move media content from the device view and/or media view to the media guide 110. U.S. patent application Ser. No. ______ (Attorney Docket No. 14276US02) filed Sep. 30, 2003 and U.S. patent application Ser. No. ______ (Attorney Docket No. 14278US02) filed Sep. 30, 2003 provides exemplary media view or guide, device view or guide, and channel view or guide, and are hereby incorporated herein by reference in their entirety.

A user of the media processing system 101 may also have the capability to subscribe to various broadcast channels and/or third (3^{rd}) party media content available on the personal media exchange network 100. For example, a user may subscribe to certain broadcast channels such as cable television channels by contacting the broadcast channel provider 117 such as a CATV provider via telephone or via the Internet using the personal computer 109. Also, the user may subscribe to, or request, certain third (3^{rd}) party media content such as image files, text file, video files and/or audio files, from the third (3^{rd}) party media provider 113. The third (3^{rd}) party media provider 113 may be an Internet radio server, an image server, a web server, a web portal, a remote personal computer and/or a remote media processing system, for example.

A media processing system may also comprise a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any personal computer may indirectly access and/or control any media peripheral device in instances where the personal computer may include a media management system. Such access and/or control may be accomplished through various communication pathways via the media processing system or outside of the media processing system. A media processing system may also have the capability to automatically access and control any media peripheral device without user interaction and/or with user intervention. A personal computer may include media exchange software running on or being executed by the personal computer and may be referred to as a media processing system. The media processing system may also include a speech recognition engine that may be adapted to receive input speech and utilize the input speech control various functions of the media processing system.

Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

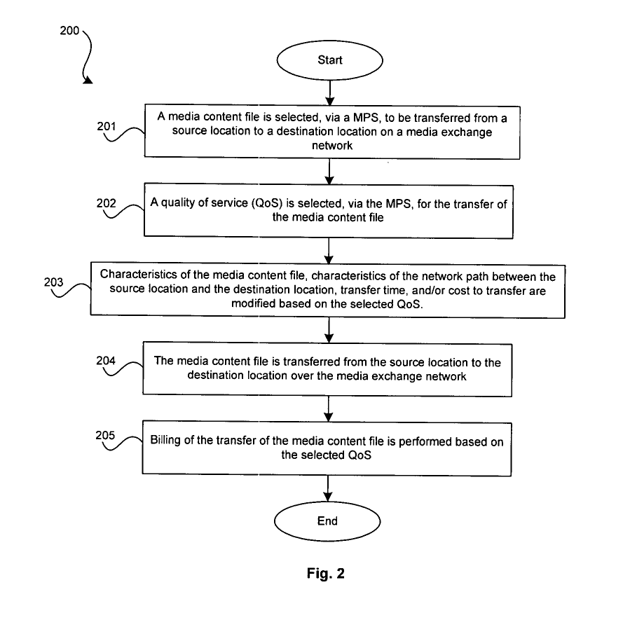

FIG. 2 is a flowchart illustrating an embodiment of an exemplary method 200 that may be utilized for scheduling personal media content and subscription based media content into a media guide on the personal media exchange network 100 of FIG. 1, in accordance with various aspects of the present invention. Referring to FIG. 1, in step 201, personal media content may be scheduled into personal media channels in a media guide of a media processing system. In step 202, broadcast channels and/or third (3^{rd}) party media content are subscribed to via a broadcast channel provider and/or a third (3^{rd}) party media provider. In step 203, a headend infrastructure accesses personal media channel schedule information from the media processing system and subscription information from the broadcast channel provider and the third (3^{rd}) party media provider. In step 204, the headend infrastructure generates an updated media guide, combining the personal media channels and the subscription channels. In step 205, the headend infrastructure transmits the updated media guide and subscription media content to the media processing system.

In an illustrative embodiment of the invention, a user of the media processing system 101 may download digital pictures from the media peripheral 108 such as a digital camera and download MP3 files from the personal computer 109 to the storage area 114 in the media processing system 101. The user of the media processing system 101 may then schedule the digital pictures and MP3 files into two different channels of the media guide 110, in accordance with an embodiment of the invention.

The user of the media processing system 101 may next subscribe to several broadcast channels such as two sports channels, a movie channel, and a gardening channel, from the broadcast channel provider 117. The user may also subscribe to some third (3^{rd}) party media content such as music from a CD jukebox and automobile commercials, from the third (3^{rd}) party media provider 113. Subscribing may be accomplished via the telephone, the Internet using a personal computer, or via the headend infrastructure and Internet infrastructure using a media processing system, in accordance with various embodiments of the present invention. In another aspect of the invention, subscribing to the broadcast channels may also be achieved via the media processing system 101 through at least one of a channel guide, media guide and/or device guide.

At a particular time of the day such as at 6:00 am, the headend infrastructure 105, using the media guide pre-processor 106, may access the personal media channel schedule information from the media processing system 101. The headend infrastructure 105 may additionally access the subscription information and associated media content from the broadcast channel provider 117 and the third (3^{rd}) party media provider 113. The headend infrastructure 105 then pre-processes all of the information and generates an updated media guide 111 comprising scheduled personal media content and scheduled subscription media content. The headend infrastructure 105 may then transmit the updated media guide 111, along with the subscription media content, to the media processing system 101. Accordingly, the next time the user utilizes the media processing system 101 to view the media guide, the updated media guide 114 will be displayed.

The media guide pre-processor 106 of the headend infrastructure 105 may be adapted to schedule third (3^{rd}) party media content and broadcast channels in a manner in which scheduling conflicts do not arise with the personal media content previously scheduled by the user of the media processing system 101. Accordingly, the media guide pre-processor 106 may include suitable software that may be configured to resolve scheduling conflicts that may arise. In another embodiment of the invention, the media guide pro-processor 106 may also be configured to present conflicts in a schedule to a user and the user may elect which media content should preferably be scheduled in order to resolve the conflict.

In another embodiment of the invention, the subscription media content may not be downloaded to the media processing system 101 until a user of the media processing system 101 actually attempts to access the subscription media content from the updated media guide. In this regard, the media processing system 101 may store the updated media guide within the storage area or storage block 114. The headend infrastructure 105 may also be adapted to update the media guide on a periodic basis such as once or twice per day.

In accordance with various embodiments of the invention, the headend infrastructure 105 may also be configured to update the media guide whenever it is determined that there is a change in a user subscription and/or account information. Notwithstanding, a schedule may also be provided for periodically updating the media guide and/or updating the media guide based on the occurrence of a triggering event. The triggering event may be the change in the user subscription and/or account information or the availability of a program that may be of interest to a user.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

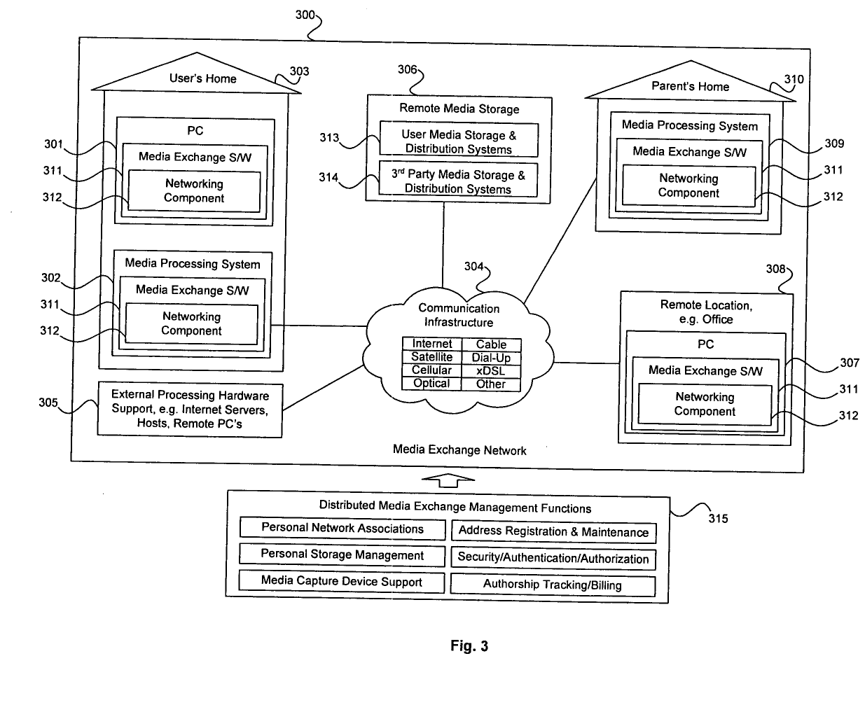

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, XDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

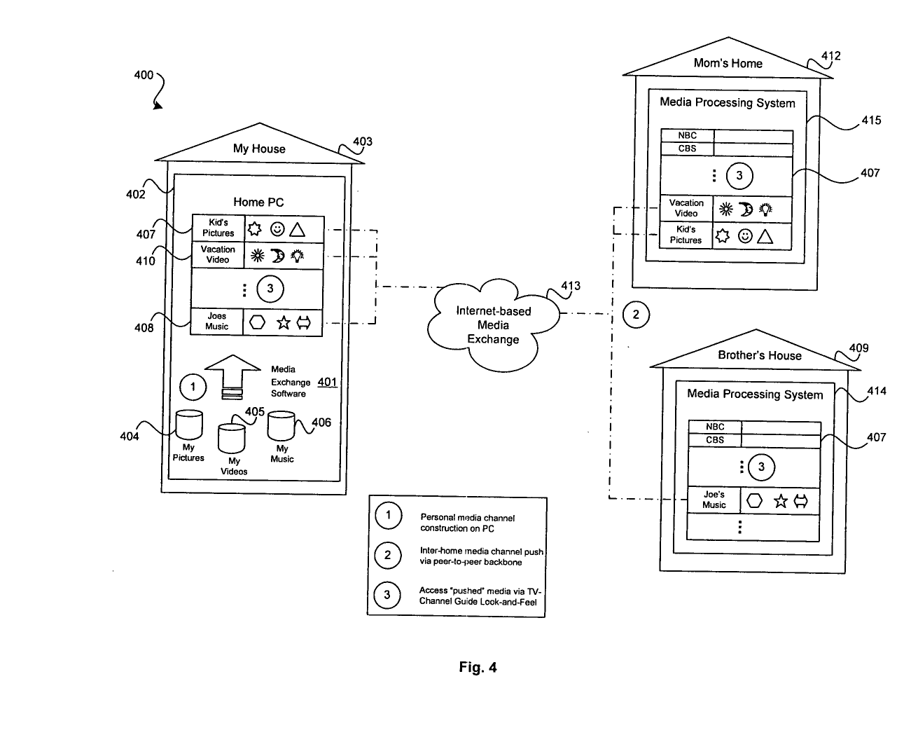

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

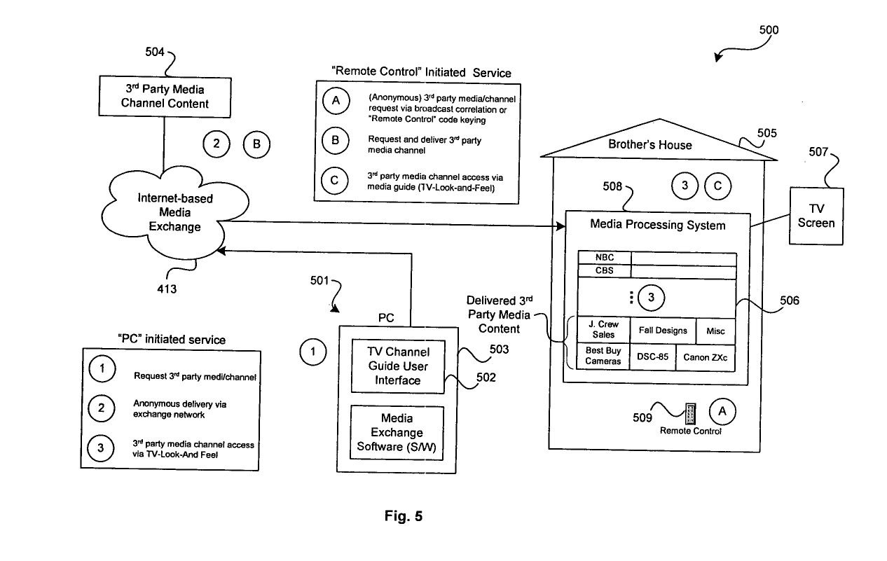

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

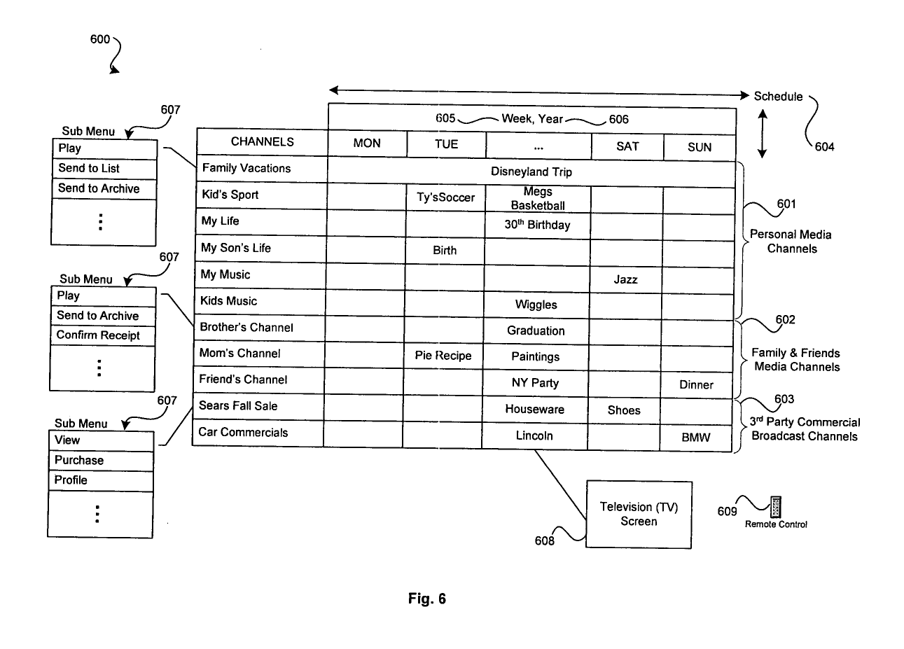

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

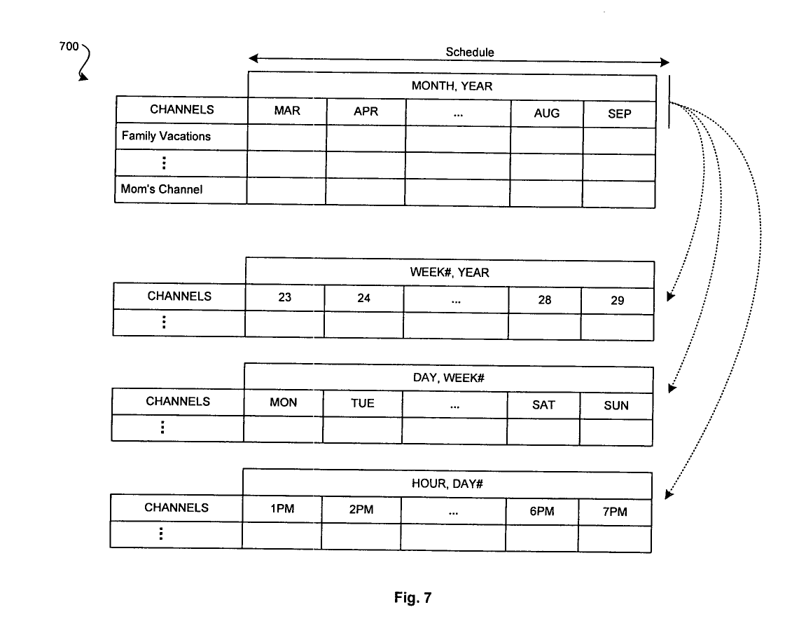

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

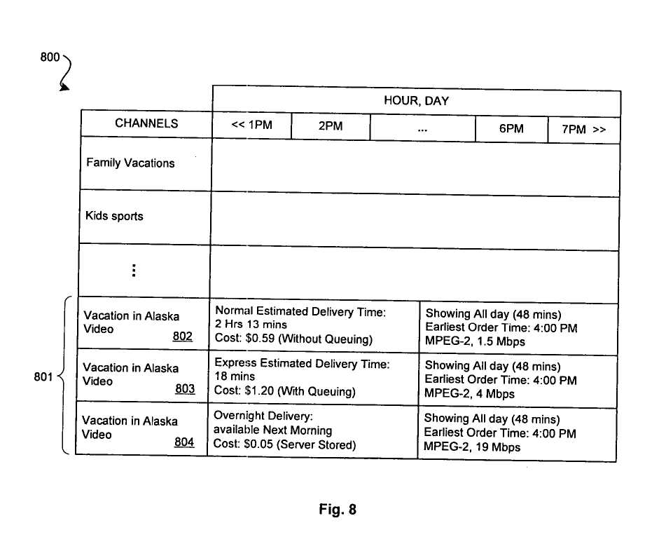

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

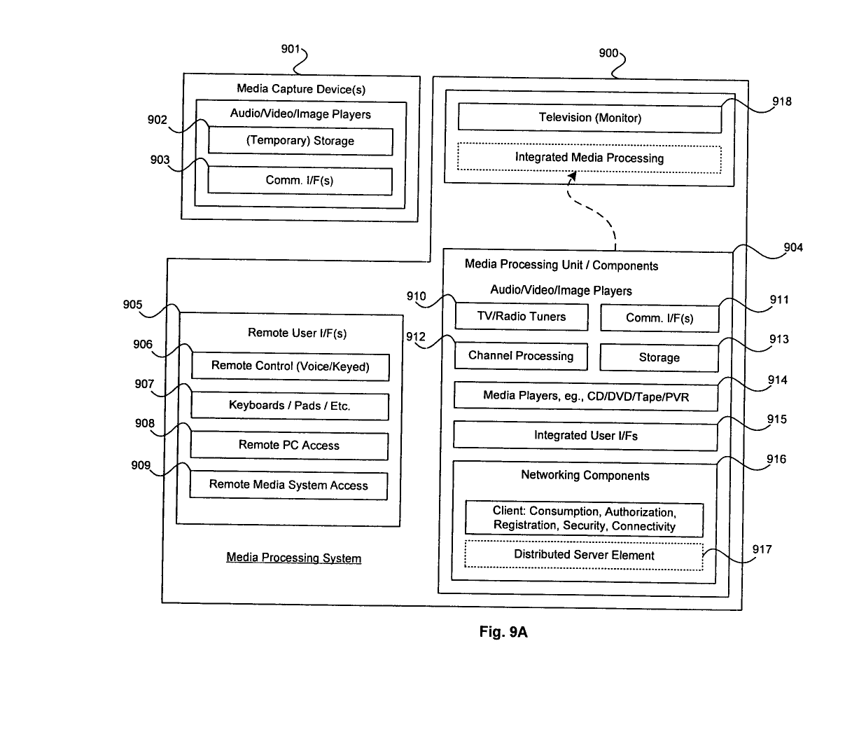

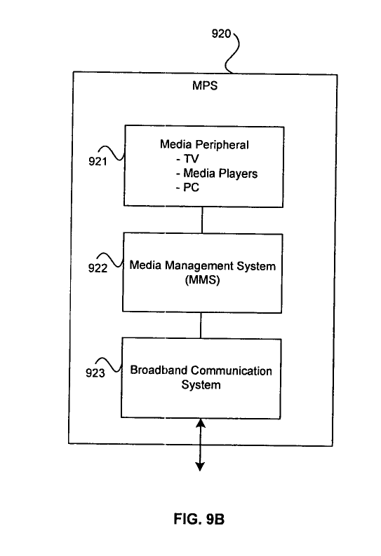

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

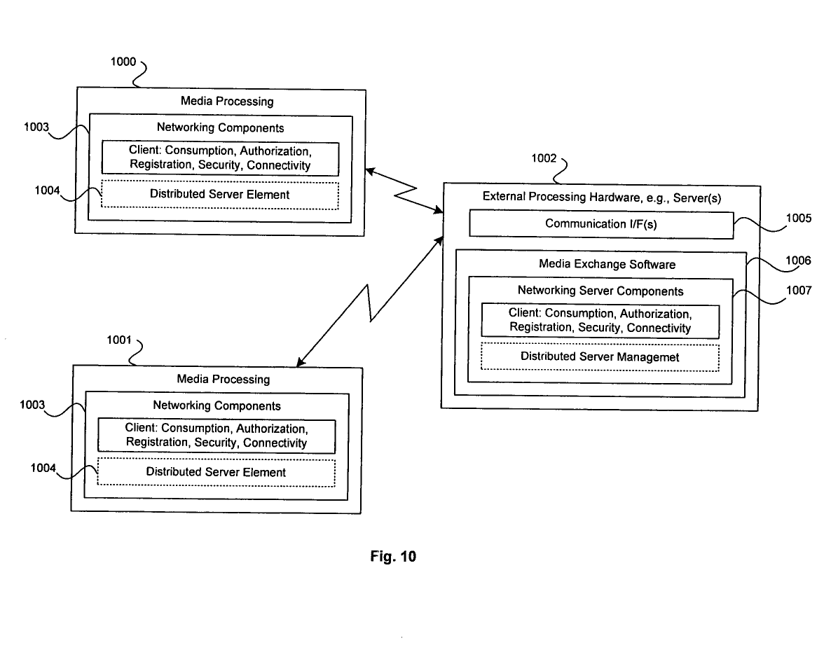

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

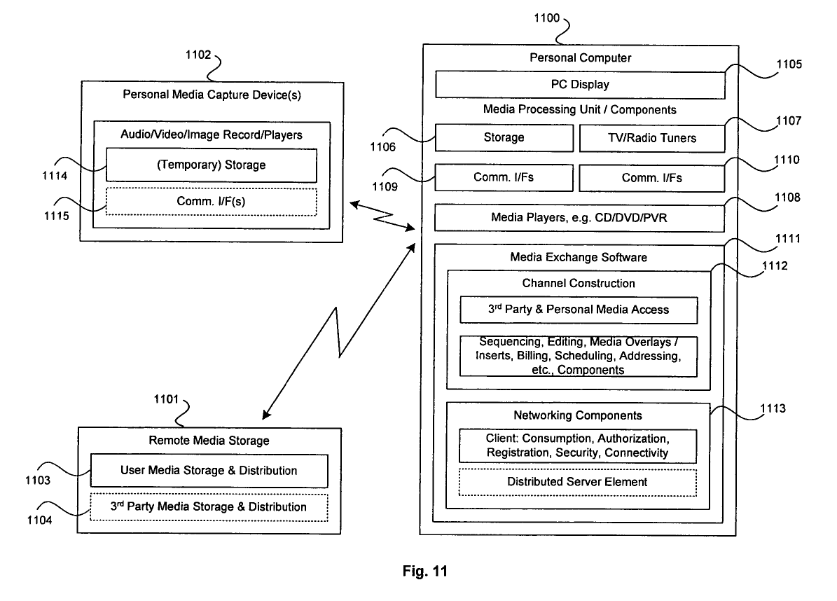

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Aspects of the system for processing media for selection and playback in a communication network may comprise at least one processor that may be adapted to determine when personal media and/or broadcast media is scheduled in a constructed display. The processor may be a headend processor or a media guide pre-processor and the constructed display may be a channel guide, a device guide and/or a media guide and may be formatted in a graphical user interface. Notwithstanding, the processor may acquire information related to the personal media and/or broadcast media from at least one media provider. Subscription information related to the media broadcast scheduled in the constructed display may be accessed in order to determine whether the constructed display should be updated. The constructed display that is updated may be transferred by the processor to, for example, a home where it may be displayed on a television screen or other display.

In accordance with an aspect of the invention, broadcast media content corresponding to the accessed subscription information may be stored by the processor and the stored broadcast media content may be communicated to a location where the updated constructed display is presented. Representations of updated broadcast media and the personal media may be generated and combined by the processor within the constructed display based on the acquired information that is related to the personal media and/or broadcast media. In another aspect of the invention, presentation of the broadcast media and/or the personal media via the updated constructed display may be rescheduled by the processor in order to prevent scheduling conflicts.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing media for selection and playback in a communication network, the method comprising:
determining when at least one of personal media and broadcast media is scheduled in at least one constructed display;
acquiring information related to said at least one of personal media and broadcast media from at least one media provider; and
updating said at least one constructed display based on said acquired information.

2. The method according to claim 1, further comprising transferring said updated at least one constructed display for presentation.

3. The method according to claim 2, further comprising accessing subscription information related to said media broadcast scheduled in said at least one constructed display.

4. The method according to claim 3, further comprising storing media broadcast content corresponding to said accessed subscription information.

5. The method according to claim 4, further comprising communicating said stored media broadcast content to a location where said updated at least one constructed display is presented.

6. The method according to claim 1, further comprising combining representations of updated broadcast media and said personal media in said at least one constructed display based on said acquired information.

7. The method according to claim 1, further comprising generating at least one updated constructed display comprising at least representations of said updated broadcast media and said personal media.

8. The method according to claim 1, further comprising rescheduling presentation of at least one of said broadcast media and said personal media via said updated at least one constructed display to prevent scheduling conflicts.

9. The method according to claim 1, wherein said at least one constructed display is at least one of a channel guide, device guide and media guide.

10. The method according to claim 1, further comprising formatting said at least one constructed display in a graphical user interface.

11. A machine-readable storage having stored thereon, a computer program having at least one code section for processing media for selection and playback in a communication network, the at least one code section being executable by a machine for causing the machine to perform steps comprising:
determining when at least one of personal media and broadcast media is scheduled in at least one constructed display;
acquiring information related to said at least one of personal media and broadcast media from at least one media provider; and
updating said at least one constructed display based on said acquired information.

12. The machine-readable storage according to claim 11, further comprising code for transferring said updated at least one constructed display for presentation.

13. The machine-readable storage according to claim 12, further comprising code for accessing subscription information related to said media broadcast scheduled in said at least one constructed display.

14. The machine-readable storage according to claim 13, further comprising code for storing media broadcast content corresponding to said accessed subscription information.

15. The machine-readable storage according to claim 14, further comprising code for communicating said stored media broadcast content to a location where said updated at least one constructed display is presented.

16. The machine-readable storage according to claim 11, further comprising code for combining representations of updated broadcast media and said personal media in said at least one constructed display based on said acquired information.

17. The machine-readable storage according to claim 11, further comprising code for generating at least one updated constructed display comprising at least representations of said updated broadcast media and said personal media.

18. The machine-readable storage according to claim 11, further comprising code for rescheduling presentation of at least one of said broadcast media and said personal media via said updated at least one constructed display to prevent scheduling conflicts.

19. The machine-readable storage according to claim 11, wherein said at least one constructed display is at least one of a channel guide, device guide and media guide.

20. The machine-readable storage according to claim 11, further comprising code for formatting said at least one constructed display in a graphical user interface.

21. A system for processing media for selection and playback in a communication network, the system comprising:
at least one processor that determines when at least one of personal media and broadcast media is scheduled in at least one constructed display;
said at least one processor acquires information related to said at least one of personal media and broadcast media from at least one media provider; and
at least one processor updates said at least one constructed display based on said acquired information.

22. The system according to claim 21, wherein said at least one processor transfers said updated at least one constructed display for presentation.

23. The system according to claim 22, wherein said at least one processor accesses subscription information related to said media broadcast scheduled in said at least one constructed display.

24. The system according to claim 23, wherein said at least one processor causes said media broadcast content corresponding to said accessed subscription information to be stored.

25. The system according to claim 24, wherein said at least one processor communicates said stored media broadcast content to a location where said updated at least one constructed display is presented.

26. The system according to claim 21, wherein said at least one processor combines representations of updated broadcast media and said personal media in said at least one constructed display based on said acquired information.

27. The system according to claim 21, wherein said at least one processor generates at least one updated constructed display comprising at least representations of said updated broadcast media and said personal media.

28. The system according to claim 21, wherein said at least one processor reschedules presentation of at least one of said broadcast media and said personal media via said updated at least one constructed display to prevent scheduling conflicts.

29. The system according to claim 21, wherein said at least one constructed display is at least one of a channel guide, device guide and media guide.

30. The system according to claim 21, further comprising formatting said at least one constructed display in a graphical user interface.

31. The system according to claim 21, wherein said at least one processor is at least one of a headend processor and a media guide pre-processor.

32. A method for processing media for selection and playback in a communication network, the method comprising:
determining from outside a home when at least one of personal media and broadcast media is scheduled in at least one constructed display that is displayed within said home;
acquiring information related to said at least one of personal media and broadcast media from at least one media provider; and
updating from outside said home, said at least one constructed display based on said acquired information.

33. The method according to claim 32, further comprising transferring said updated at least one constructed display for presentation within said home.

34. The method according to claim 33, further comprising accessing from outside said home, subscription information related to said media broadcast scheduled in said at least one constructed display that is displayed within said home.

35. The method according to claim 34, further comprising storing outside said home, broadcast media content corresponding to said accessed subscription information.

36. The method according to claim 35, further comprising communicating said stored broadcast media content to said home where a representation of said broadcast media is presented in said at least one constructed display.

37. The method according to claim 32, wherein said at least one constructed display is at least one of a channel guide, device guide and media guide.

38. The method according to claim 32, further comprising formatting said at least one constructed display in a graphical user interface.
